(19) United States
(12) Patent Application Publication
(10) Pub. No.: US 2013/0080999 A1
(43) Pub. Date: Mar. 28, 2013

(54) Automated Testing for Hosted Applications on Various Computing Platforms

(71) Applicant: Shuishi Yang, Bellevue, WA (US)

(72) Inventor: Shuishi Yang, Bellevue, WA (US)

(73) Assignee: MICROSOFT CORPORATION, Redmond, WA (US)

(21) Appl. No.: 13/245,037

(22) Filed: Sep. 26, 2011

(51) Int. Cl. G06F 9/44

(52) U.S. Cl. 717/124

(57) ABSTRACT

The subject disclosure is directed towards automating tests for a hosted application on various computing platforms. An interface is provided for tested the hosted application. The interface processes one or more registered test commands for a test service and selects a test service address that corresponds with an underlying computing platform. The interface routes the one or more registered test commands to the test service address and communicates test results in response to the one or more registered test commands.

### BACKGROUND

Cloud computing applications provide computing capability that is delivered as a utility through network (i.e., Internet) standards and protocols. Some cloud computing applications may be accessed by anyone, such as customers paying for goods and services with a credit card. Some cloud computing applications are configured for the exclusive use of a business or a consortium of businesses. Nonetheless, these cloud computing applications are hosted by a variety of technologies (e.g., MICROSOFT® Windows Azure and/or the like). As an example, cloud-based relational database management systems (RDBMS) (e.g., MICROSOFT® SQL Azure) host enterprise database applications.

These cloud-based technologies may utilize a group or cluster of physical computers and/or a cluster of virtual machines that in general treat physical computing, storage and networking resources as a homogenous pool for the purpose of hosting and managing an application for various consumers. When the hosted application is online and accessible, such a cluster may be typically referred to as a live or production environment. When the hosted application is being tested, the cluster may be typically referred to a staging or testing environment. These cloud-based technologies may also provide a single machine to simulate functionality of the cluster in order run various tests on the hosted application.

Prior to deploying versions of the hosted application to the live or production environment, developers deploy these versions to the testing or staging environment running on the single machine, the cluster or another computing platform. When creating automated tests for the hosted application, the developers implement the same tests for both the single machine simulating the cluster and an actual cluster. Such a practice is redundant and deviates developer focus from testing functions on the hosted application to writing code for connecting to different computing platforms.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards an interface that enables automated testing of hosted applications on various computing platforms. In one aspect, automated test code is only implemented once instead of being implemented for each computing platform. In one aspect, a test service is deployed along with a hosted application for the purpose of running tests on various functions. Because the hosted application and the test service reside on a same cluster or machine, the tests may access the hosted application locally. As such, the automated test code may invoke generic test commands that refer to a specific test implemented by the test service.

In another aspect, a testing component (i.e., a unified test component) configures appropriate connection settings and hosted application version settings (e.g., build definitions) for the test service that is deployed across the various computing environments. Hence, the unified test component manages the test service on behalf of the automated test code. When the automated test code invokes one of the generic test commands, the unified test component routes the test command to an appropriate address for a test service running on an underlying computing platform.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram illustrating an exemplary system for testing hosted applications on various computing platforms according to one example implementation.

FIG. 2 is a block diagram illustrating an exemplary unified test component for hosted applications on various computing platforms according to one example implementation.

FIG. 3 is a flow diagram illustrating exemplary steps for testing hosted applications on various computing platforms according to one example implementation.

FIG. 4 is a flow diagram illustrating exemplary steps for bypassing a unified test component when routing test commands to a test service address according to one example implementation.

FIG. 5 is a flow diagram illustrating exemplary steps for selecting an appropriate test service address for executing test commands according to one example implementation.

FIG. 6 is an interactive diagram illustrating an exemplary sequence of interactions between components of an exemplary system for providing a unified test component for hosted applications on various computing platforms according to one example implementation.

FIG. 7 is a block diagram representing exemplary non-limiting networked environments in which various embodiments described herein can be implemented.

FIG. 8 is a block diagram representing an exemplary non-limiting computing system or operating environment in which one or more aspects of various embodiments described herein can be implemented.

### DETAILED DESCRIPTION

Various aspects of the technology described herein are generally directed towards automating tests for hosted applications on various computing platforms. In one exemplary implementation, a testing component, such as a unified test component as described herein, facilitates use of generic, registered test commands that refer to specific tests executed by a test service running on the various computing platforms. The testing component stores test service addresses associated with each computing platform. As a result of the testing component, developers do not have to deal with the complexity and differences of the various computing platforms, nor with the expense of adapting each test for each platform.

In one exemplary implementation, each address refers to a test service that corresponds with a specific version of the hosted application. Such a test service runs tests on one or more functions that are implemented by the specific version of the hosted application. In another exemplary implementation, each test service address also includes a reference to an implementation of the generic test command on the test service. Instead of writing automated test code that triggers the implementation on each of the various computing platforms, the developers invoke the generic test command once and the testing component identifies the specific version of the hosted application, locates the test service and triggers the corresponding implementation on behalf of the developers.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and testing in general.

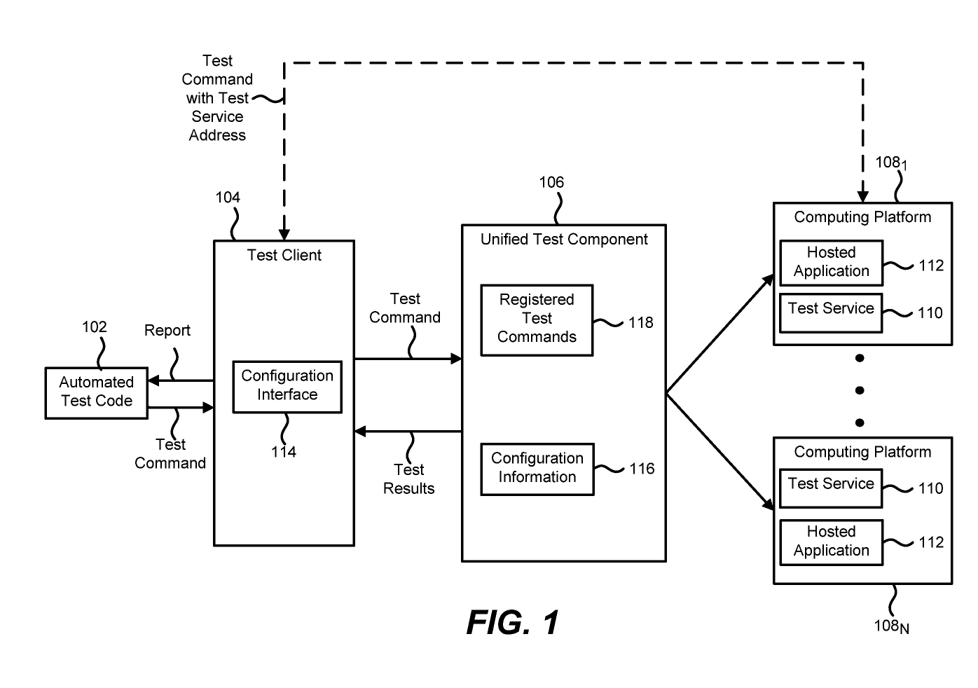

FIG. 1 is a block diagram illustrating an exemplary system for testing hosted applications on various computing platforms according to one example implementation. In one exemplary implementation, the exemplary system includes various components, such as automated test code 102, a test client 104, a unified test component 106 and various computing platforms 108_{1 . . . N}. The test client 104 uses the unified test component 106 to deploy a test service 110 onto each computing platform 108. The test service 110 may be designed for execution on any of the various computing platforms 108, such as a cloud simulator or a computer cluster, as described herein.

Each test service 110 includes modules that may be located in the cloud, along with a hosted application 112 (e.g., a database application). Alternatively, the test service 110 may be located on-premises, and connected to the hosted application 112, which may also be local. The hosted application 112 may include one or more services and/or executables (e.g., binaries) that expose functions (e.g., application programming interfaces (APIs)) to the test service 110. The test service 110 runs tests (e.g., generic tests) on these functions and returns test results (e.g., function output indicating pass or failure with errors).

Because different groups of software developers may be working on expanding features on the hosted application 112, each computing platform 108 may include various versions of the same hosted application 112 according to one exemplary implementation. Each version, for example, may be deployed to a staging environment for testing before deployment to a production environment as a live application. Therefore, the test service 110 may correspond with a specific version of the hosted application and may run tests on functions that pertain to that particular version. As explained herein, the test service 110 includes an implementation for methods testing each of these functions. As described herein, a unified test component 106 identifies the certain test service 110 and also identifies a corresponding implementation for testing a particular function.

Each test service 110 address includes a Domain Name System (DNS) name as well as an assigned Internet Protocol (IP) address. The test services 110 and the test client 104 communicate messages through industry-standard Internet service interfaces, such as Representational State Transfer (REST). In one exemplary implementation, the test service 110 accesses a database with a publicly known protocol named Tabular Data Stream (TDS) over TCP/IP.

An exemplary address for the test service 110 may include various values, such as a host name, a unique identifier or an Internet Protocol (IP) address. For example, the test service 110 hosted locally with the unified test component 106 is addressed using the host name “localhost”. As another example, the test service 110 hosted remotely on a server instance, such as a computer in a physical cluster, is located using a custom domain name or IP address. The test service 110 address may also specify a port number, such as port eighty-one (81). Via the unified test component 106, the test client 104 configures the test service 110 with a custom domain name in order to construct correct connection Uniform Resource Identifiers (URI), such as a Uniform Resource Locator (URL) or a Uniform Resource Name (URN), to the test service 110 according to one exemplary implementation.

According to one exemplary implementation, the test client 104 includes a configuration mechanism 114. Using the configuration mechanism 114, the automated test code 102 deploys the test services 110 onto the various computing platforms 108 and stores identifiers for local data sources or networked server instances that host the test services 110 in configuration information 116. The configuration mechanism 114 may also be used to set up databases on the various computing platforms 108 and record database identifiers in the configuration information 116 according to one exemplary implementation.

The unified test component 106 uses one or more interfaces to access local resources on the various computing platforms 108, such as the test service 110 and/or a version of the hosted application 112. The unified test component 106 stores an address for each test service 110 in the configuration information 116. The unified test component 106 also establishes various credentials (e.g., an account name, a login, a password and/or the like) for accessing the test service 110 in the configuration information 116.

According to one exemplary implementation, the unified test component 106 is coupled to one or more computers within the various computing platforms 108 and includes the configuration information 116 and registered test commands 118. The unified test component 106 exposes an interface to the test client 104 for calling the registered test commands 118. The unified test component 106 may be executed on a server that manages the test service 110 running on another computer within a physical cluster. Alternatively, the unified test component 106 may be executed on a same computer running the test service 110. Such a computer may be a local machine or a remote computer within the physical cluster.

In one exemplary implementation, the registered test commands 118 are generic and therefore, applicable to any of the various computing platforms 108. Instead of using separate instructions for each of the various computing platforms 108, the automated test code 102 invokes one or more of the registered test commands 118. In response, the unified test component 106 communicates each invoked test command to the test service 110 associated with an underlying computing platform, which is an actual local or remote resource running the hosted application 112.

In one exemplary implementation, the hosted application 112 is a web-based email communication and management service (e.g., MICROSOFT® Hotmail). When testing an updated or new feature, such as a SPAM filter or send media file, the unified test component 108, the test service 110 and the hosted application 112 are deployed to testing environment on a remote computer within the physical cluster or a local machine. Using the unified test component 108, software developers register a generic command for testing the updated or new feature.

For instance, the generic command may be labeled “testSendMediaFile” and include one or more parameters (e.g., body text, a send email address, a media file content and/or the like). In order to run a test associated with the send media file function, the unified test component 108 routes the “testSendMediaFile” command to the test service 110. In response, the test service 110 creates a fake email using the provided parameters, inserts text, attaches the media file and sends the fake email to a recipient. If the email is successfully communicated, the test service 110 communicates a pass test result. If, on the other hand, the email is not received by the recipient, the test service 110 returns a test result indicating a failure. Subsequently, the unified test component 108 communicates the test result to the test client 104 for viewing.

In one exemplary implementation, the unified test component 106 reads environment related data and determines the underlying computing platform, which may include a computer cluster or a local computer running a cloud/cluster simulator. Subsequently, the unified test component 106 selects the test service address for the appropriate test service 110 being hosted on the underlying computing platform and routes the test commands to such an address. If the underlying computing platform changes, the unified test component 106 replaces the test service address and communicates the test commands to the corresponding test service 110 on another underlying computing platform. It is appreciated that the present disclosure envisions numerous ways to perform such a routing. For example, the appropriate test service address may be combined with the test commands in any appropriate manner.

In one exemplary implementation, because the test service 110 may correspond with a specific version of the hosted application 112, the automated test code 102 does not have to specify such a version on which to run various tests. Accordingly, the automated test code 102 may not include build identifiers for the version of the hosted application 112. Based on the invoked test command, the unified test component 106 correctly identifies this version using a number of techniques.

In one exemplary implementation, the unified test component 106 examines the registered test commands 118 and identifies a function (i.e., a method) being tested by the invoked test command. Then, the unified test component 106 identifies the version of the hosted application 112 that implements the function. For example, the unified test component 106 employs a well-known type matching technique (e.g., reflections) that recognizes a function having similar or identical parameters, signatures, command-line argument types and/or environment variables. Once recognized, the unified test component 106 identifies a version of the test service 110 associated with testing the function. The unified test component 106 routes the invoked test command to an appropriate address for this version of the test service 110.

In another exemplary implementation, the test service 110 may also include a specific corresponding implementation for the invoked test command. The unified test component 106 matches the invoked test command with the corresponding implementation on the test service 110 by, for example, comparing environment variables for the invoked test command with a source code specification for test commands implemented by the test service 110. A test command implementation on the test service 110 with identical environment variables matches the invoked test command. By communicating the invoked test command to the test service 110 and identifying the corresponding implementation, the unified test component 106 triggers execution of one or more function tests on the version of the hosted application 112 associated with the test service 110.

Because the automated test code 102 is unaware of the underlying computing platform, the unified test component 106 opens and closes connections to the underlying computing platform on behalf of the automated code 102 according to one exemplary implementation. Via the unified test component 106, the test client 104 uses these connections to route test commands to the test service 110. The unified test component 106 uses one or more interfaces (e.g., a common topology interface) to manage these connections and facilitate test command execution. Alternatively, the test client 104 may directly manage the connections to the underlying computing platform and communicate the test commands directly to the test service 110 without the unified test component 106.

The unified test component 106 uses the configuration information 116 to connect to the test service 110 in a variety of ways, such as ADO.NET, PHP, and Open Database Connectivity (ODBC). In one exemplary implementation, the configuration information 116 includes connection strings for the various computing platforms 108. Whenever the underlying computing platform changes, the unified test component 106 may replace the connection string being used to route the test commands. An example format for the connection string may include the following:
Server=tcp:[serverName].database.windows.net;Database=[DataBaseName]; Uid=[LoginForDb]@[serverName];Pwd=[Password];Encrypt=yes;

In one exemplary implementation, the configuration information 116 includes connection settings for a local computing platform and a cloud computing platform, such as the following:
Local: <Setting name=“DataConnectionString” value=“UseDevelopmentStorage=true”/>
Cloud: <Setting name=“DataConnectionString” value=“DefaultEndpointsProtocol=http;AccountName=<your account>;AccountKey=<your account key”/>

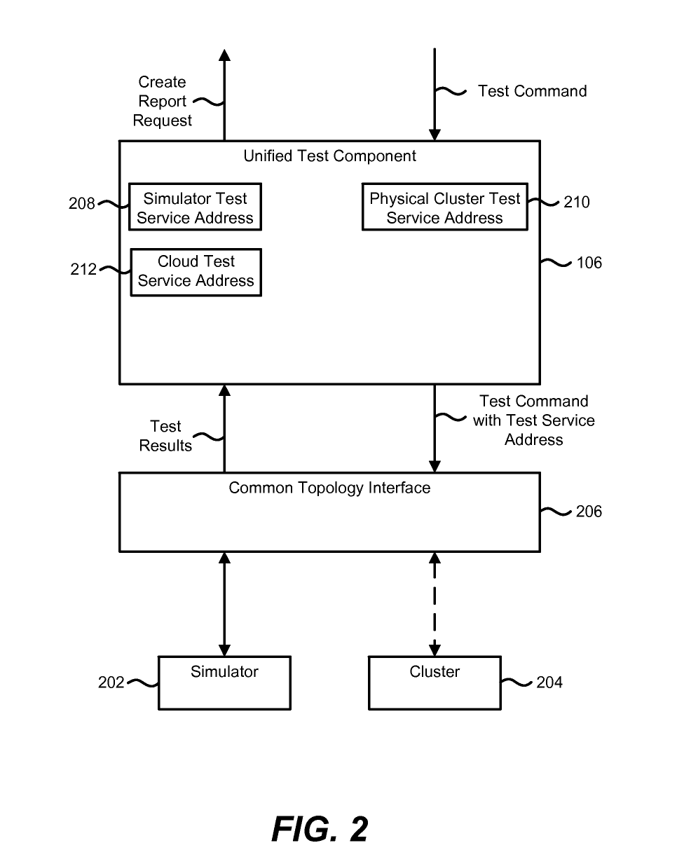

FIG. 2 is a block diagram illustrating an exemplary unified test component 106 for hosted applications on various computing platforms according to one example implementation. As explained herein, the unified test component 106 configures connections to an underlying computing platform on which a hosted application is tested. FIG. 2 depicts, as an example and not a limitation, a simulator 202 as the underlying computing platform. The simulator 202 emulates a computer cluster, such as cluster 204, on a single, local computer.

The unified test component 106 uses a common topology interface 206 to access a test service associated with one or more databases. In one exemplary implementation, the unified test component 106 combines a registered test command with a corresponding test service address and communicates the registered test command to the common topology interface 206. The common topology interface 206 locates the test service running on the simulator 202 and communicates the registered test command. In response, the test service performs various operations testing a hosted application (i.e., a version of the hosted application) according to an exemplary implementation.

When the test service returns test results (e.g., pass or fail for generic tests), the common topology interface 206 relays them back to the unified test component 106. The test results may be converted into a standard report typically used for hosted application test automation. In one exemplary implementation, the unified test component 106 may utilize a reporting service (e.g., a cloud simulator-based or a cloud-based reporting service, such as MICROSOFT® SQL Azure Reporting Limited CTP built on SQL Azure and SQL Server Reporting Services technologies) to publish and manage reports that display the test results. Such a reporting service may be running on a test client. The unified test component 106 may also configure the test service to collect diagnostic data when running various tests according to one exemplary implementation. The unified test component 106 may configure various test settings to specify the diagnostic data of interest. For example, the unified test component 106 may select diagnostic data adapters that control the manner at which the test service operates.

In one exemplary implementation, automated test code invokes a test command for which the unified test component 106 identifies the test service address for the test service. Because in this implementation the simulator 202 hosting the test service is located on the local computer, the test service address includes a hostname “localhost” and a file system location of the test service. Hence, a simulator test service address 208 may be similar to the following example:
“http://localhost:81/OpStoreTestActionInjectSingleTrace?node=waterstone06.node4”

The unified test component 106, on behalf of the automated test code, uses the simulator test service address 208 to open a connection to the simulator 202 and communicate the test command to the test service. In one exemplary implementation, the unified test component 106 combines the test command with the simulator test service address 208. As a response, the common topology interface 206 triggers an implementation of a corresponding test on the test service that effectuates the test command.

In one exemplary implementation, if the underlying computing platform switches to the cluster 204, the test client 104 responds by opening a connection and routing the test command to a test service being hosted on the cluster 204. It is appreciated that the cluster may be a physical cluster or a group of virtual machines emulating the physical cluster. The test client 104 selects a physical cluster test service address 210 that may resemble the following example:
“http://65.66.23.97:81/BBBPlatform20/OpStoreTestActionInjectSingleTrace?node=B88CDB14062314.NODE90”

In one exemplary implementation, the unified test component 106 combines (e.g., inserts into an address field or replaces an existing address with) this address into the test command of which the common topology interface 202 communicates to the test service. Alternatively, the test client 104 temporarily disables software code referencing the simulator test service address 208 within the test command using comments or reflections. Similar to the test service on the simulator 202, the test service being hosted by the cluster 204 returns test results (e.g., pass or fail) after completing various operations in accordance with the test command.

In yet another exemplary implementation, the test client 104 configures a custom domain name for locating the test service being hosted on the cluster 204 instead of an IP address. Such a domain name becomes a portion of a cloud test service address 212, such as set forth in the following example:
“http://bbopstore.cloudapp.net:81/OpStoreTestActionInjectSingleTrace?node=SQL0A1CCDD1.NODE48”

Accordingly, the unified test component 106 routes the test command to the cloud test service address 212 via the common topology interface 206. The cloud test service address 212 resolves to a corresponding IP address, which is used to locate the test service being hosted on the cluster 204.

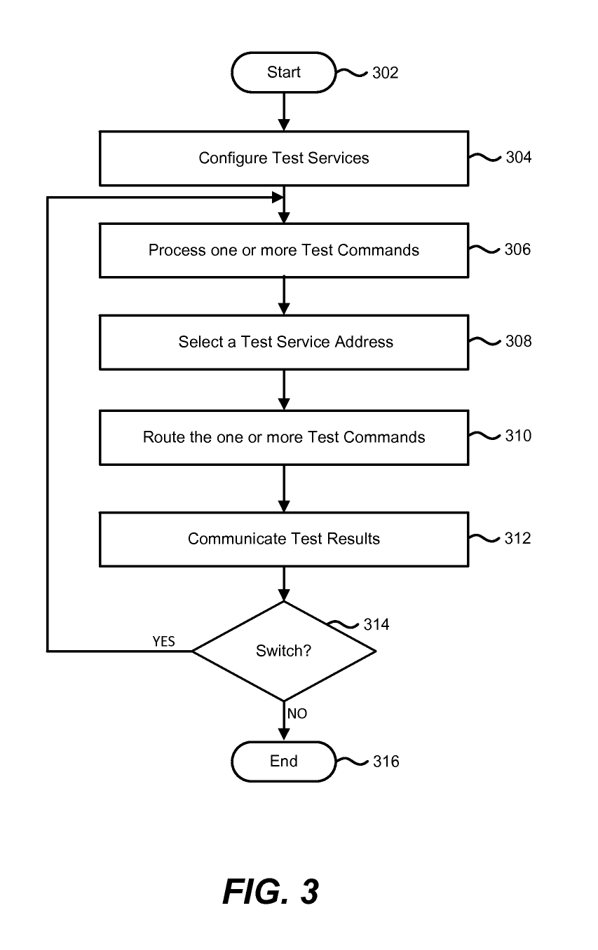

FIG. 3 is a flow diagram illustrating exemplary steps for testing a hosted application on various computing platforms according to one example implementation. It is appreciated that the exemplary steps may be performed by the unified test component 106 as illustrated in FIG. 1-2 or, alternatively, another testing component running on the test client 104. These example steps describe a method that commences at step 302 and proceeds to step 304 at which the unified test component 118 configures one or more test services running on various computing platforms. The unified test component 118 processes configuration information that includes various settings as well as test service addresses within a cluster simulator on a local computer or a physical cluster. The unified test component 118 uses the configuration information to establish connections to resources on the local computer or the physical cluster when necessary.

Step 306 refers to accessing one or more test commands from automated test code. Such test commands do not assume a particular underlying computing platform and may be applied when a test service is located on a cloud simulator or an actual cloud environment. Such test commands are registered on the unified test component 118 and used to trigger a corresponding test on the test services according to one exemplary implementation.

Step 308 is directed to detecting an underlying computing platform and selecting a test service address. The unified test component 118 determines whether the test service is located in the cloud simulator or the actual cloud environment. Then, the unified test component 118 combines the appropriate test service address with the one or more test commands. Step 310 is directed to routing the one or more test commands to the appropriate test service address.

After waiting for one or more tests to complete, the unified test component 108 receives test results for the one or more test commands from the test service. Step 312 is directed to communicating test results for the one or more commands to the test client 104. In one exemplary implantation, the test client 104 receives a request to create a report from the unified test component 108. Such a request includes the test results that are provided by the test service. Using the report, the automated code verifies that a hosted application works properly and/or identifies errors in the database or the hosted application itself.

Step 314 is determination as to whether the underlying computing platform switched to another computing platform. If the underlying computing platform changed, the method described in FIG. 3 returns to step 306 where the test client receives a next test command. If, on the other hand, the underlying computing platform did not switch to the other underlying computing platform, the method described in FIG. 3 proceeds to step 316. The method described in FIG. 3 terminates at step 316.

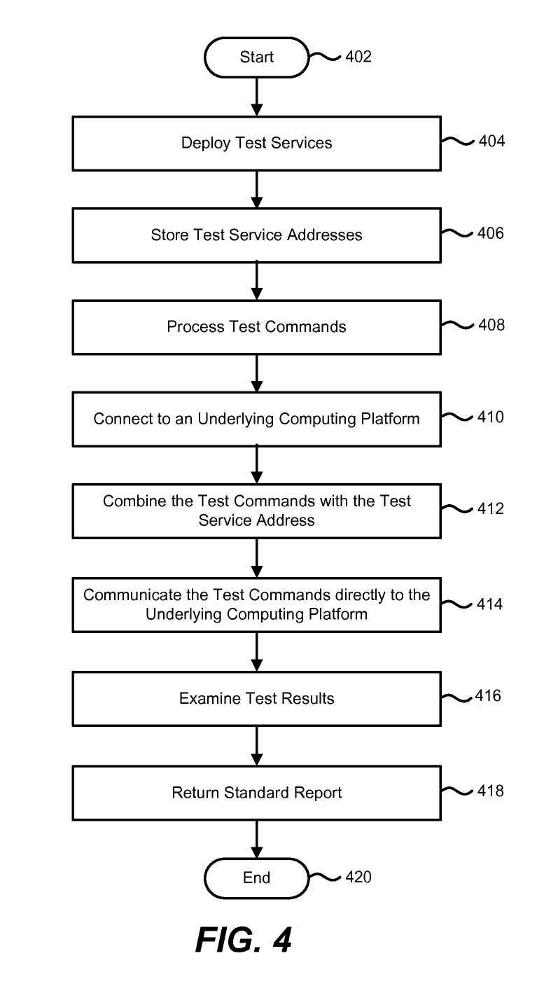

FIG. 4 is a flow diagram illustrating exemplary steps for bypassing a unified test component when routing test commands to a test service address according to one example implementation. These example steps describe a method that commences at step 402 and proceeds to step 404 at which the test client 104 deploys test services onto various computing platforms. Step 406 is directed to storing test service addresses in configuration information in addition to various connection settings (e.g., account names, server names and data sources) and credentials (e.g., login name and password) for accessing the test services. The various connection settings also describe the computing platforms that host the test services.

Step 408 represents processing test commands from automated test code. These test commands refer to sets of pre-defined registered instructions for using the test services to perform certain tests on functions of the hosted application. Step 410 illustrates the detection and connection to an underlying computing platform. In one exemplary implementation, the test client 104 identifies which one of the various computing platform is available for connectivity. Then, the test client 104 examines the configuration information and identifies an appropriate test service address for connecting with the underlying computing platform.

Step 412 refers to combining the test commands with an appropriate test service address. These the appropriate test service is used to open a connection to the underlying computing platform and execute the test service. The test client 104 may use any one of the .NET Framework programming languages (e.g., MICROSOFT® Visual Basic, MICROSOFT® Visual C#, or MICROSOFT® Visual C++) when communicating the test commands to the test service. The test client 104 may also call various providers or drivers (e.g., ADO.NET data provider, the SQL Server 2008 Native Client ODBC driver, and the SQL Server 2008 Driver for PHP version 1.1 and/or the like).

Step 414 is directed to communicating the test commands directly to the underlying computing platform. In one exemplary implementation, the test client 104 bypasses the unified test component 118. The test client 104 may still use a common topology interface to relay these test commands to the underlying computing platform. Step 416 refers to examining test results that indicate whether the test service failed or succeeded. Step 418 represents generating and returning a standard report using the test results using a native reporting service (e.g., MICROSOFT® Test Manager). The method described in FIG. 4 terminates at step 420.

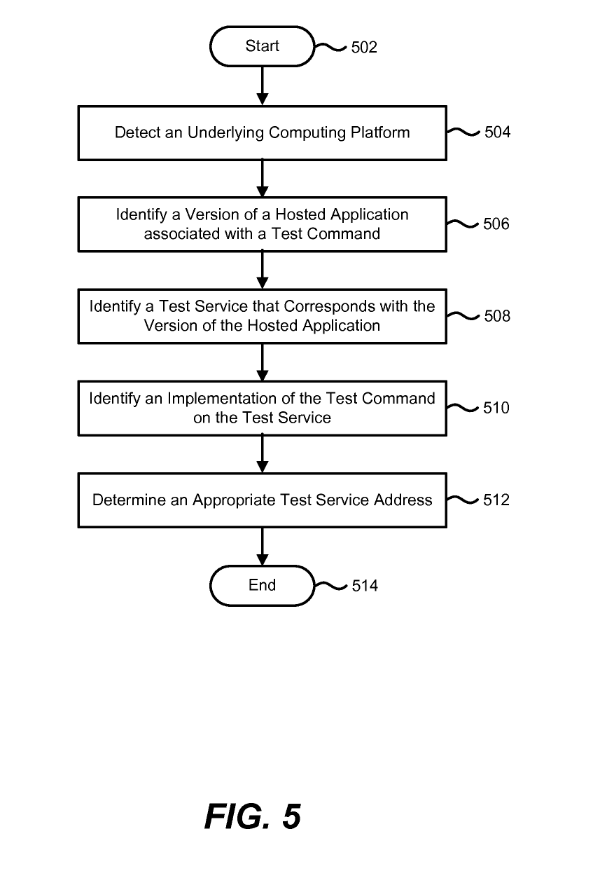

FIG. 5 is a flow diagram illustrating exemplary steps for selecting an appropriate test service address for executing test commands according to one example implementation. It is appreciated that these steps are performed by the unified test component 106 illustrated by FIG. 1-2 or, alternatively, another testing component running on the test client 104. These steps describe a method that commence at step 502 and proceeds to step 504 at which the unified test component 106 detects an underlying computing platform.

Step 506 is directed to identifying a version of a hosted application associated with a test command. As described herein, automated test code invokes the test command for testing a certain function. After verifying that the test command is registered, the unified test component 106 matches various parameters (e.g., environment variables or command line options) of the certain function with specific source code associated with the version of the hosted application according to one exemplary implementation. Hence, the matching version of the hosted application implemented the certain function being tested.

Step 508 refers to identifying a test service that corresponds with the version of the hosted application. As explained herein, after deploying the version of the hosted application, a corresponding test service is deployed to run tests on various functions. Hence, the test command invoked by the automated test code references the corresponding test service. The unified test component 106 examines various configuration information and selects an address associated with the corresponding test service running on the underlying computing platform according to one exemplary implementation.

Step 510 represents the identification of an implementation of the test command on the test service. In addition to identifying the test service associated with the invoked test command, the unified test component 106 selects the corresponding implementation within such a test service by matching signature data. If a signature of the test command matches a certain implementation that, when triggered, runs various tests on one or more functions, the unified test component 106 selects the certain implementation for execution.

Step 512 illustrates a determination of an appropriate test service address. In one exemplary implementation, the unified test component 106 examines the configuration information and extracts the test service address that corresponds with the version of the hosted application as well as the implementation of the test command. Subsequently, the unified test component 106 routes the test command to the test service address as explained herein. The method described in FIG. 5 terminates at step 514.

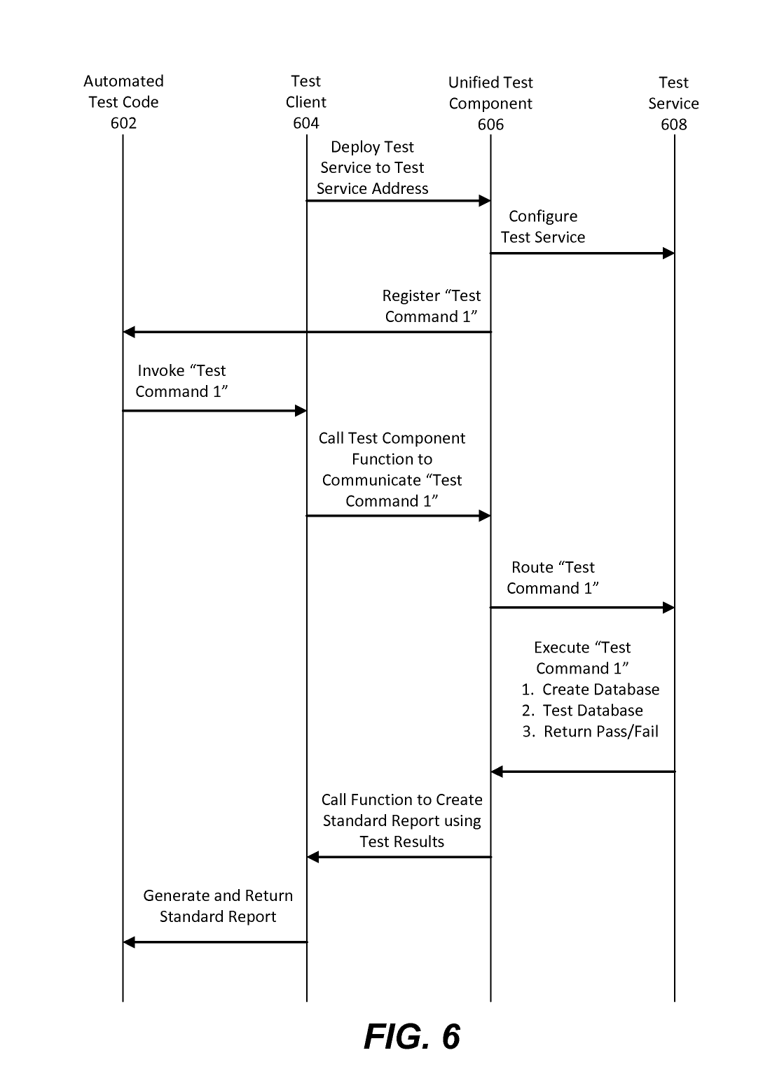

FIG. 6 is an interactive diagram illustrating an exemplary sequence of interactions between example components of an exemplary system for providing a unified test component for hosted applications on various computing platforms according to one example implementation. In one exemplary implementation, the example components include automated test code 602, a test client 604, a unified test component 606 and a test service 608. As explained herein, the unified test component 606 may include the unified test component 106 running on the various computing platforms or another testing component running on the test client 604.

In one exemplary implementation, the test client 604 deploys the test service 608 to a test service address via a configuration mechanism (e.g., the configuration mechanism 112 of FIG. 1). Such a deployment may occur subsequent to deployment of a version of a hosted application. The unified test component 606 configures the test service on behalf of the test client 604. The unified test component 606 establishes various connection settings and credentials for accessing the test service 608 and records the test service address.

As illustrated, once deployed and configured on an underlying computing platform, the unified test component 606 registers various test commands, such as “test command 1” associated with the test service 608, and provides information on using these commands to the test client 604. The automated test code 602 invokes “test command 1” for which the test client 604 calls the unified test component 608 function to communicate the “test command 1” to the test service 608. In one exemplary implementation, the unified test component 606 combines the test service address into the “test command 1” invocation. Then, the “test command 1” is routed to the test service address. In one exemplary implementation the unified test component 606 communicates the “test command 1” to a corresponding implementation on the test service 608.

Once received, the test service 608 executes the implementation that corresponds with “test command 1”. For example, the test service 608 creates a database, tests the database using various criteria and returns test results to the unified test component 606 in the form of pass/fail. The unified test component 606 responds by calling a function on the test client 604 to create a standard report. The test client 604 generates and returns the standard report back to the automated code where such a report is examined for errors in the hosted application.

### Exemplary Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

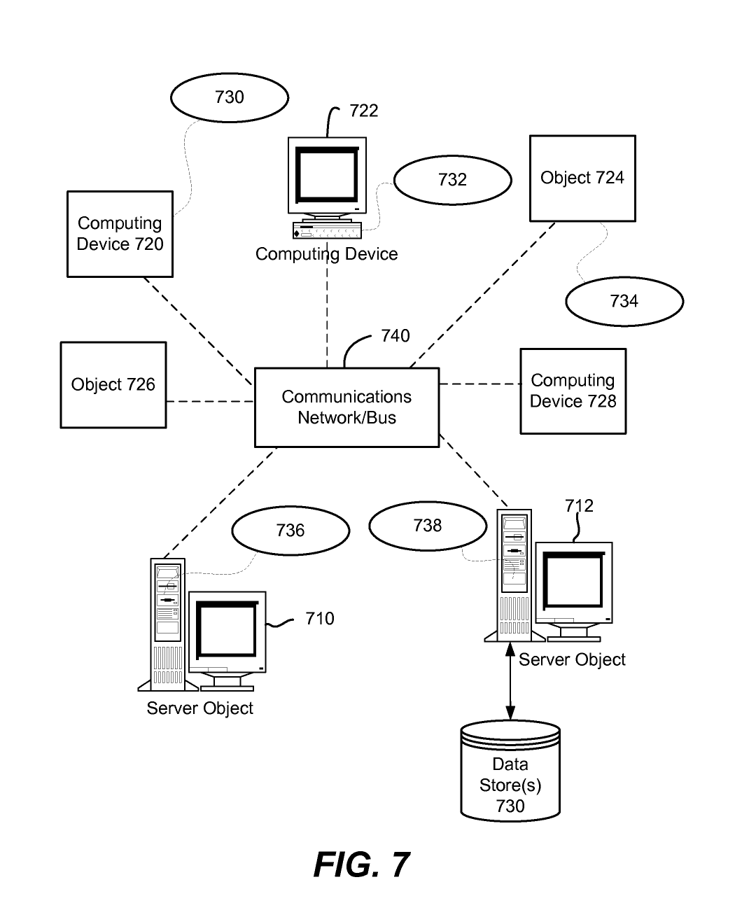

FIG. 7 provides a schematic diagram of an exemplary networked or distributed computing environment. The distributed computing environment comprises computing objects 710, 712, etc., and computing objects or devices 720, 722, 724, 726, 728, etc., which may include programs, methods, data stores, programmable logic, etc. as represented by example applications 730, 732, 734, 736, 738. It can be appreciated that computing objects 710, 712, etc. and computing objects or devices 720, 722, 724, 726, 728, etc. may comprise different devices, such as personal digital assistants (PDAs), audio/video devices, mobile phones, MP3 players, personal computers, laptops, etc.

Each computing object 710, 712, etc. and computing objects or devices 720, 722, 724, 726, 728, etc. can communicate with one or more other computing objects 710, 712, etc. and computing objects or devices 720, 722, 724, 726, 728, etc. by way of the communications network 740, either directly or indirectly. Even though illustrated as a single element in FIG. 7, communications network 740 may comprise other computing objects and computing devices that provide services to the system of FIG. 7, and/or may represent multiple interconnected networks, which are not shown. Each computing object 710, 712, etc. or computing object or device 720, 722, 724, 726, 728, etc. can also contain an application, such as applications 730, 732, 734, 736, 738, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 7, as a non-limiting example, computing objects or devices 720, 722, 724, 726, 728, etc. can be thought of as clients and computing objects 710, 712, etc. can be thought of as servers where computing objects 710, 712, etc., acting as servers provide data services, such as receiving data from client computing objects or devices 720, 722, 724, 726, 728, etc., storing of data, processing of data, transmitting data to client computing objects or devices 720, 722, 724, 726, 728, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 740 or bus is the Internet, for example, the computing objects 710, 712, etc. can be Web servers with which other computing objects or devices 720, 722, 724, 726, 728, etc. communicate via any of a number of known protocols, such as the hypertext transfer protocol (HTTP). Computing objects 710, 712, etc. acting as servers may also serve as clients, e.g., computing objects or devices 720, 722, 724, 726, 728, etc., as may be characteristic of a distributed computing environment.

### Exemplary Computing Device

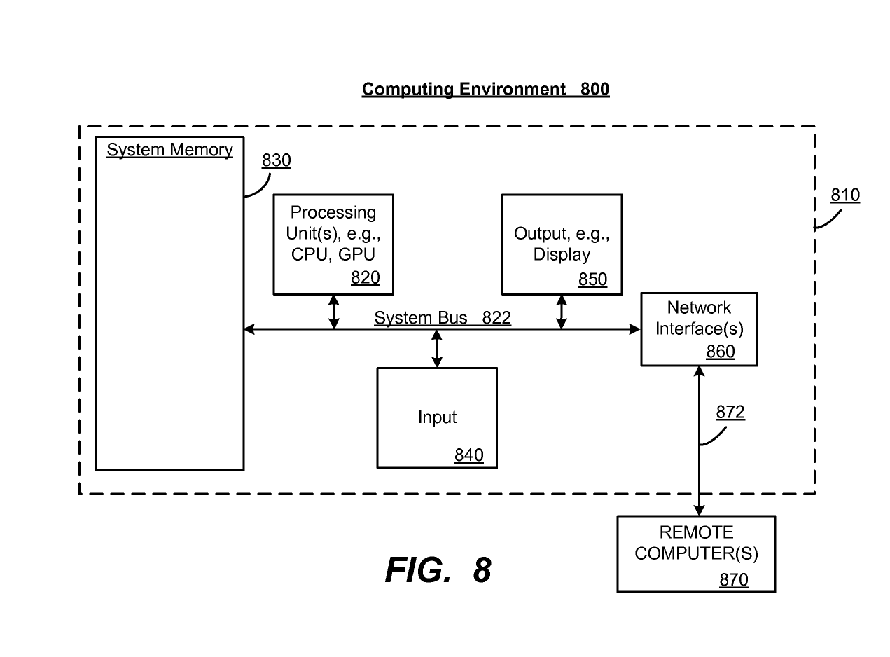

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 8 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 8 thus illustrates an example of a suitable computing system environment 800 in which one or aspects of the embodiments described herein can be implemented, although as made clear above, the computing system environment 800 is only one example of a suitable computing environment and is not intended to suggest any limitation as to scope of use or functionality. In addition, the computing system environment 800 is not intended to be interpreted as having any dependency relating to any one or combination of components illustrated in the exemplary computing system environment 800.

With reference to FIG. 8, an exemplary remote device for implementing one or more embodiments includes a general purpose computing device in the form of a computer 810. Components of computer 810 may include, but are not limited to, a processing unit 820, a system memory 830, and a system bus 822 that couples various system components including the system memory to the processing unit 820.

Computer 810 typically includes a variety of computer readable media and can be any available media that can be accessed by computer 810. The system memory 830 may include computer storage media in the form of volatile and/or nonvolatile memory such as read only memory (ROM) and/or random access memory (RAM). By way of example, and not limitation, system memory 830 may also include an operating system, application programs, other program modules, and program data.

A user can enter commands and information into the computer 810 through input devices 840. A monitor or other type of display device is also connected to the system bus 822 via an interface, such as output interface 850. In addition to a monitor, computers can also include other peripheral output devices such as speakers and a printer, which may be connected through output interface 850.

The computer 810 may operate in a networked or distributed environment using logical connections to one or more other remote computers, such as remote computer 880. The remote computer 880 may be a personal computer, a server, a router, a network PC, a peer device or other common network node, or any other remote media consumption or transmission device, and may include any or all of the elements described above relative to the computer 810. The logical connections depicted in FIG. 8 include a network 882, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, testing a hosted application on various computing platforms, including, processing one or more registered test commands for a test service, selecting a test service address that corresponds with an underlying computing platform, routing the one or more registered test commands to the test service address, and communicating test results in response to the one or more registered test commands.

2. The method of claim 1, wherein selecting the test service address further comprises identifying a version of the hosted application associated with the one or more registered test commands.

3. The method of claim 2 further comprising communicating the one or more registered test commands to the test service address associated with the version of the hosted application.

4. The method of claim 1, wherein communicating the test results further comprising producing a report using the test results.

5. The method of claim 1, wherein routing the one or more registered test commands further comprises executing a corresponding implementation on the test service for each test command.

6. The method of claim 1, wherein the test service address includes a simulator test service address.

7. The method of claim 1, wherein the test service address includes a cluster test service address.

8. The method of claim 1, wherein routing the one or more registered test commands further comprises determining whether the underlying computing platform switches to another underlying computing platform, and if so, selecting a test service address that corresponds with the other underlying computing platform.

9. The method of claim 1, wherein routing one or more registered test commands further comprising bypassing a unified test component when communicating with the underlying computing platform.

10. In a computing environment, a system, comprising, a testing component coupled to one or more computing platforms and configured to test a hosted application, wherein the testing component is further configured to identify an underlying computing platform, select a test service that corresponds with the hosted application on the underlying computing platform, communicate one or more registered test commands to the test service, and process test results for the one or more registered test commands.

11. The system of claim 10, wherein the testing component is further configured to identify a version of the hosted application that corresponds with the one or more registered test commands and to communicate the one or more registered test commands to a test service address associated with the version of the hosted application.

12. The system of claim 10, wherein the testing component identifies a corresponding implementation for each test command on the test service.

13. The system of claim 12, wherein the test service executes tests on functions implemented by the hosted application.

14. The system of claim 10, wherein the testing component generates a report comprising the test results for the one or more registered test commands.

15. The system of claim 10 further comprising a test client configured to deploy a plurality of test services on the various computing platforms, wherein the test client routes the one or more registered test commands to a test service address that corresponds with a version of the hosted application running on the underlying computing platform.

16. The system of claim 15, wherein the test client comprises the testing component, the testing component communicates directly with the test service associated with the version of the hosted application.

17. The system of claim 10, wherein the testing component registers the one or more registered test commands.

18. The system of claim 10, wherein the testing component routes the one or more registered test commands to a test service address that corresponds to the other underlying computing platform when the underlying computing platform switches to another underlying computing platform.

19. One or more computer-readable media having computer-executable instructions, which when executed perform steps, comprising:
configuring one or more settings for utilizing each test service on various computing platforms;
identifying an underlying computing platform comprising a test service for a version of a hosted application;
routing one or more registered test commands to a corresponding test service address; and
returning test results in response to the one or more registered test commands.

20. The one or more computer-readable media of claim 19 having further computer-executable instructions comprising:
communicating each test command to a corresponding implementation on the test service.
